(19) United States
(12) Patent Application Publication
(10) Pub. No.: US 2003/0170603 A1
(43) Pub. Date: Sep. 11, 2003

(54) Audio generating assembly for book and the like

(76) Inventors: Hsieh-Ching Chen, Taichung (TW); Yung-Ping Liu, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 10/090,634

(22) Filed: Mar. 6, 2002

(51) Int. Cl. G09B 5/00

(52) U.S. Cl. 434/317

(57) ABSTRACT

An audio generating assembly, which is working for book, clear book, photo album and the like. The audio generating assembly has a case. The case has an attaching segment thereon for engaging to a secure device attached on a book and the like to detachable fasten the case to the book and the like. The case has a sensor array, a set of auxiliary lights, a main controller unit, a message storage unit and a speaker therein. The sensors are to receive reflecting light from bar codes on pages of the book of the like to identify the page. The auxiliary lights are to illuminating the bar code in a poor ambient light condition. The message storage unit can store audio messages therein and broadcast the audio message corresponding to the identified page via the speaker.

### FIELD OF THE INVENTION

The present invention relates generally to an audio player, and more particularly to an audio generating assembly for book and the like.

### BACKGROUND OF THE INVENTION

Conventional interactive talking book is to provide a specific purposed book and an audio player assembly. The audio player assembly can identify the pages of the book and broadcast the audio message according to the page of the book to be turned.

In prior art, U.S. Pat. No. 6,064,855 (Ho) taught a voice book system, which has a book with a sheet body and an information storing device at each page of the book. A sound generating device is to hold the back cover of the book. The sound generating device has detecting means respectively corresponding to each the sheet body of the page of the book. If the book is turned to a specific page, the sheet bodies will cover predetermined detecting means. Each of the detecting means has a signal emitter and a signal receiver. The signal emitter can emit an optical signal and the signal receiver can receive the optical signal. If the sheet body covers the detecting means, the signal receiver will receive the reflecting optical signal from the signal emitter to identify the present page. We found Ho's voice book system will have false detecting in brighter environment.

U.S. Pat. No. 4,884,974 (DeSmet) disclosed another way to identify pages of a book. DeSmet provides a code bar, which is composed of a row of reflecting and non-reflecting elements, on each page of the book. A sensor array can receive ambient light of reflecting or non-reflecting from the code bar to identify the present page. DeSmet had told in the specification that the detecting function will fail in a darker environment.

In addition, we found there must be a specific purposed book provided in the prior art. The audio player assembly can not work without the specific purposed book. Readers will be boring after a few times of reading the book.

### SUMARY OF THE INVENTION

The primary objective of the present invention is to provide an audio generating assembly for book and the like, which can work correctly both in brighter and darker environment.

Another objective of the present invention is to provide an audio generating assembly for book and the like, there is no specific purposed book and the like being needed to work with the audio generating assembly.

According to the objectives of the present invention, an audio generating assembly for book and the like comprises a case being to detachable fasten to a book and the like. A sensor array is to receive reflecting light from bar codes on pages of the book and the like for identifying the present page to be turned. A set of auxiliary lights are to illuminate the bar codes in a poor ambient light condition. A message storage unit is to store audio messages therein according to the identified page. A speaker is to broadcast the audio message, and a power supply is to provide the necessary electric power.

### BRIEF DESCRIPTION OF THE DRAWINGS

FIG. 1 is an exploded view of a first prefer embodiment of the present invention;

FIG. 2 is a perspective view of the first prefer embodiment of the present invention;

FIG. 3 is a block diagram of the first prefer embodiment of the present invention;

FIG. 4 is a perspective view of the first prefer embodiment of the present invention, showing the audio generating assembly installing to a book.

FIG. 5 shows the relationship of the sensor array of the audio generating assembly and the code bar on the book.

FIG. 6 shows the sensor array detecting the code bar, and the auxiliary lights illuminating the code bar.

FIG. 7 is a perspective view of the second prefer embodiment of the present invention;

FIG. 8 is a block diagram of the second prefer embodiment of the present invention, and

FIG. 9 is a perspective view of the third prefer embodiment of the present invention.

### DETAIL DESCRIPTION OF THE INVENTION

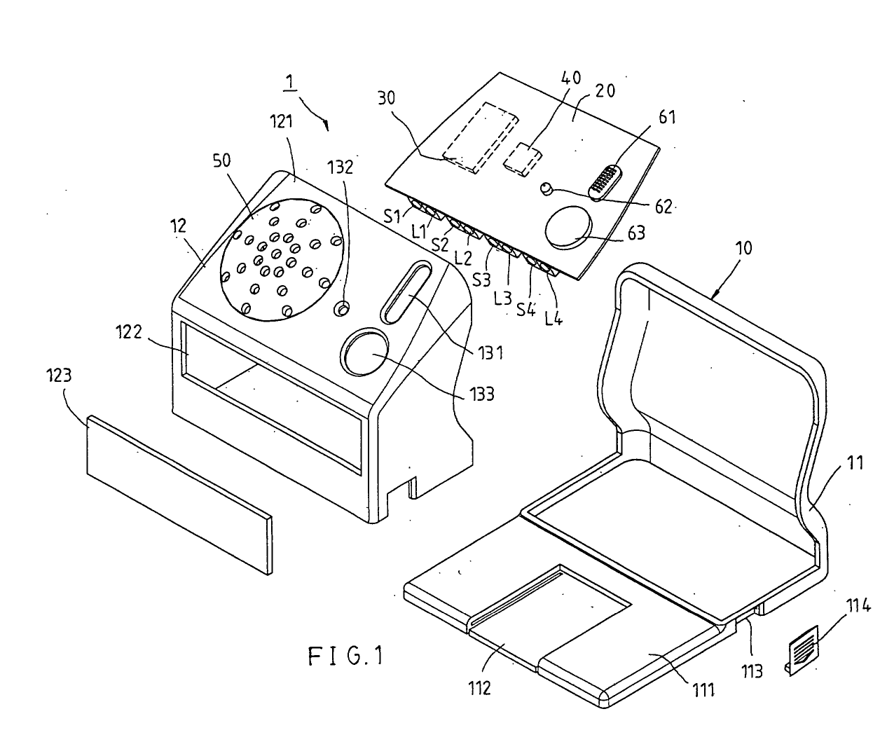

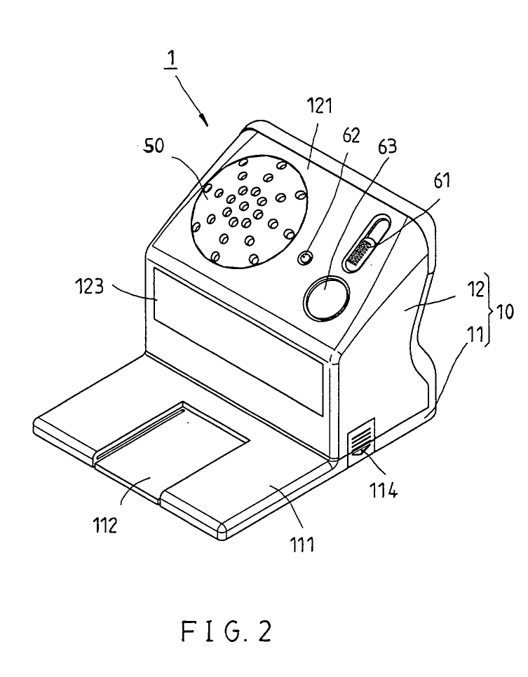

Please refer to FIGS. from FIG. 1 to FIG. 3, the first prefer embodiment of the present invention provides an audio generating assembly 1, which is to attach to a book, a booklet, a photo album, a clear book, a data holder and the like for broadcasting specific audio message according to the pages of the book and the like to be turned, comprising the following elements.

A case 10 has a seat 11 and a housing 12. The seat 11 is a substantially L-shaped plank element, which has an attaching segment 111 and a slot 112 at the distal end of the attaching segment 111. The seat 11 further has a battery slot 113 at a lateral side thereof for receiving batteries (not shown) therein and has a cover 114 covering the battery slot 113. The housing 12 is secured to the seat 11 to form a receiving space therein. The housing 12 has an inclined panel 121 at the topside, which has openings 131, 132 and 133 thereon. The housing 12 further has a window 122 at front side thereof. A transparent piece 123 disposes at the window 122.

A circuit board 20 receives in the receiving space of the case 10 and is secured at the interior side of the panel 121 of the housing 12 for electrical conducting and transmitting signals. The front end of the circuit board 20 is inclining downward about 45 degrees.

Four sensors S1 to S4 dispose on the circuit board 20 at the front end of the bottom side. The sensors S1 to S4 can receive optical signals reflected from a code bar BC, which is set on each page of the book and the like, via the window 122 to provide an identify signal.

Please refer to FIG. 5, the sensors S1 to S4 are inclining downward along the circuit board 20 to detect the code bar BC directly. So there is no mirror provided in the present invention to reflect the optical signals as taught by DeSmet's U.S. Pat. No. 4,884,974.

Four auxiliary lights L1 to L4 dispose on the circuit board 20 at the front end of the bottom side. The sensors S1 to S4 and the auxiliary lights L1 to L4 are arrange to be four pairs on the circuit board 20, each pair of which has a sensor and an auxiliary light. The auxiliary lights L1 to L4 are to illuminate the bar code BC via the widow 122.

A main controller unit 30, which is a single-chip microprocessor, installs on the circuit board 20 for receiving the identify signal from the sensors S1 to S4.

A message storage unit 40 installs on the circuit board 20 for storing audio messages therein according to the identify signal.

A speaker 50 is secured at the interior side of the panel 121 of the housing 12 for broadcasting audio message.

A power switch 61 disposes on the circuit board 20 corresponding to the opening 131 of the panel 121 for turning on and turning off the power supply.

An indicator 62 disposes on the circuit board 20 corresponding to the opening 132 of the panel 121 for indicating the status of the audio generating assembly 1 of the present invention.

A play switch 63 disposes on the circuit board 20 corresponding to the opening 133 of the panel 121 for turning on and turning off the playing function of the audio generating assembly 1 of the present invention.

Hereunder we well describe how the audio generating assembly 1 of the present invention working for a book 100.

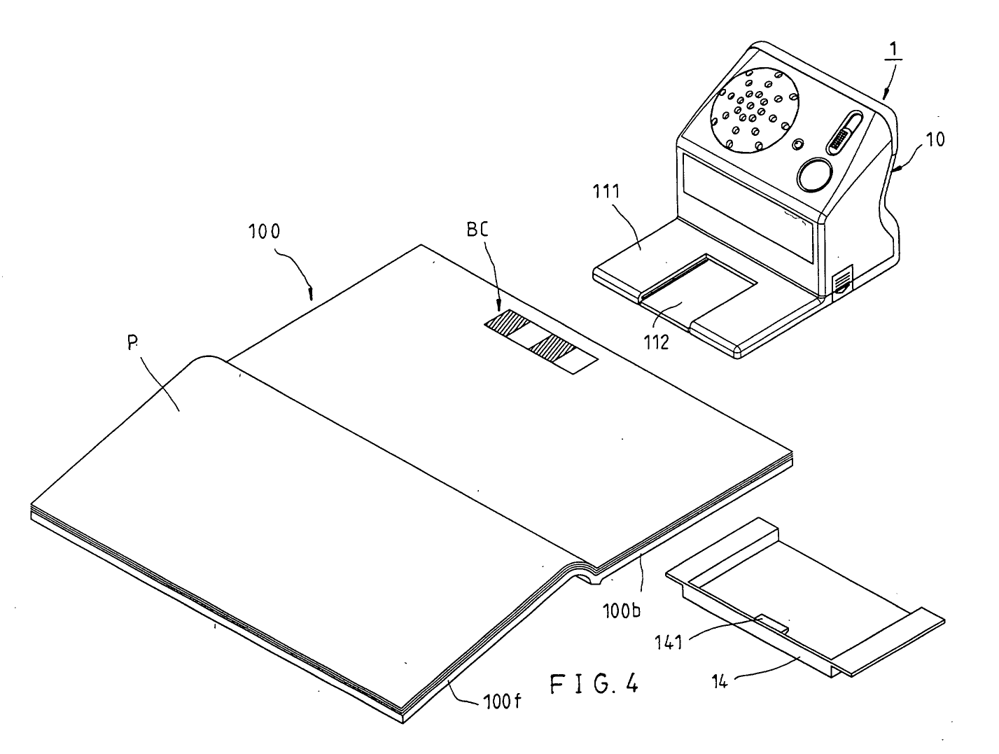

Please refer to FIG. 4, the book 100 has a front cover 100f, a back cover 100b and pages P for printing texts and pictures (not shown) thereon. The present invention further comprises a secure device 14 attached at the exterior side of the back cover 100b of the book 100. The secure device 14 is attaching to the book 100 by means of a repeat-adhesive tape (not shown) in the present embodiment.

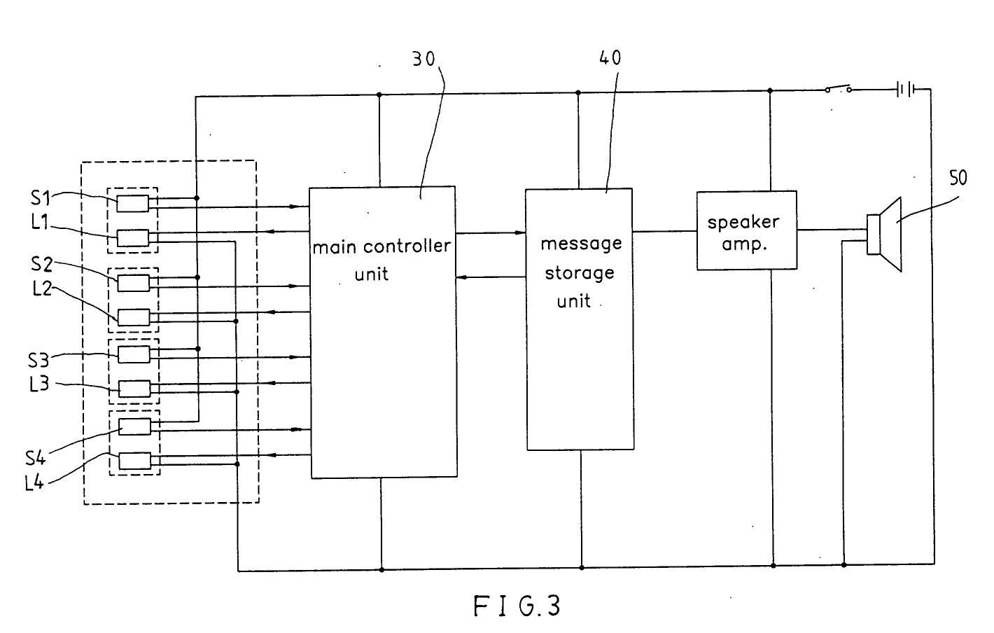

Please refer to FIG. 3, the case 10 fastens to the book 100 by means of engaging the attaching segment 111 to the secure device 14. In the meantime, a block 141 at the interior end of the secure device 14 is engaging to the slot 112 on the attaching segment 111. Thus, the case 10 is fixedly fastened to the book 100. When not use, user only needs to pull the case 10 out of the secure device 14.

In addition to the way of fastening the case 10 to the book 100 that described above, we also can provide a repeat-adhesive tape (not shown) on the attaching segment 111 to detachable attach the case 10 to any book and the like.

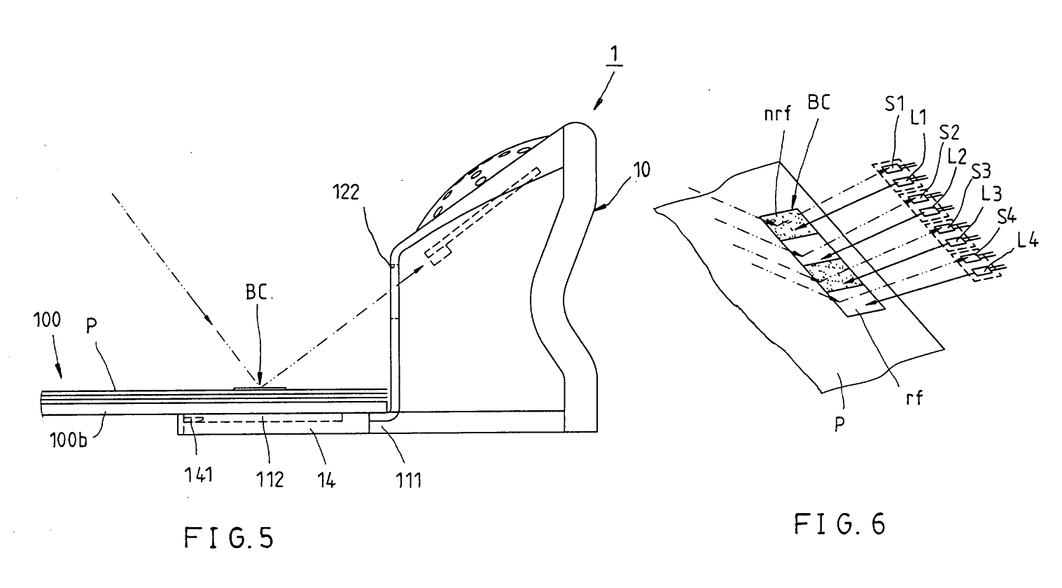

Please refer to FIG. 5 and FIG. 6, each page P of the book 100 provides with a bar code BC thereon for representing the present page P. The bar code BC is composed with a row of reflecting and non-reflecting elements for reflecting ambient light to the sensors S1 to S4. The principle of the sensors S1 to S4 identifying the bar code BC is as same as the DeSmet's U.S. Pat. No. 4,884,974, so I will not describe the detail here.

The bar codes BC of the present embodiment are printed on tapes, and are respectively attaching the tapes on the pages P of the book 100. Thus, user can attach the tapes with the bar codes BC thereon to the pages of any book, photo album and the like. So, the audio generating assembly 1 of the present invention can work for any book and the like.

It is easy to know that we can print the bar codes BC on the pages P directly or user paints the bar codes BC on papers by himself/herself in a predetermined formation for the sensors S1 to S4 to detect.

When reader turns to one page P of the book 100, the sensors S1 to S4 will detect the bar code BC on the page P automatically and transmit an identify signal to the main controller unit 30. The main controller unit 30 will find the corresponding audio message in the message storage unit 40 and broadcast the message via the speaker 60. When reader turns to another page, the sensors S1 to S4 will detect the bar code BC on the present page and broadcast the audio message according to the identified page.

Please refer to FIG. 6, in a poor ambient light condition, the auxiliary lights L1 to L4 will turn on automatically to illuminate the bar code BC. Thus the sensors S1 to S4 can receive enough reflecting light from the bar code BC to avoid false detecting in a dark environment.

In present invention, the main controller unit will turn on the auxiliary lights L1 to L4 automatically in a dark environment. There are another ways for it, such as the auxiliary lights L1 to L4 are always turning on when turns on the power switch 61 or provides another controller (not shown) on the panel 121 for user to operate.

The amounts of the sensors and the auxiliary lights are the choice of manufacturer. But the amounts of the reflecting and non-reflecting elements of the bar code should be equal to the amounts of the sensors.

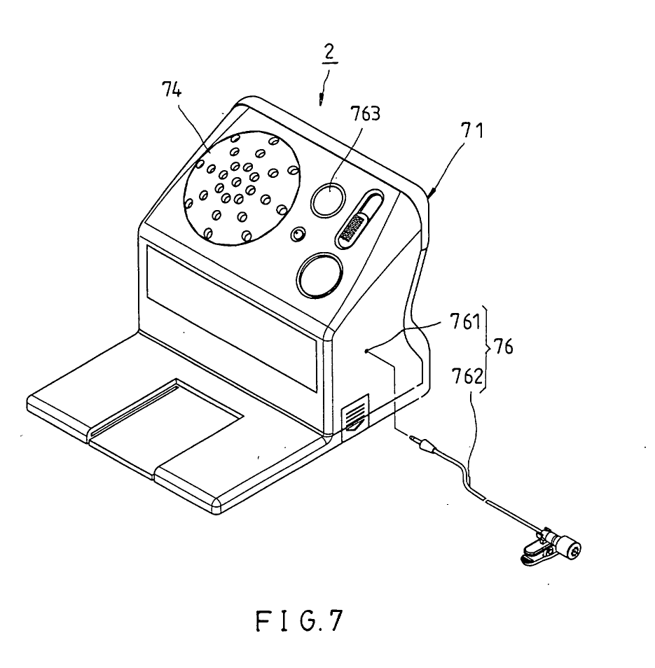

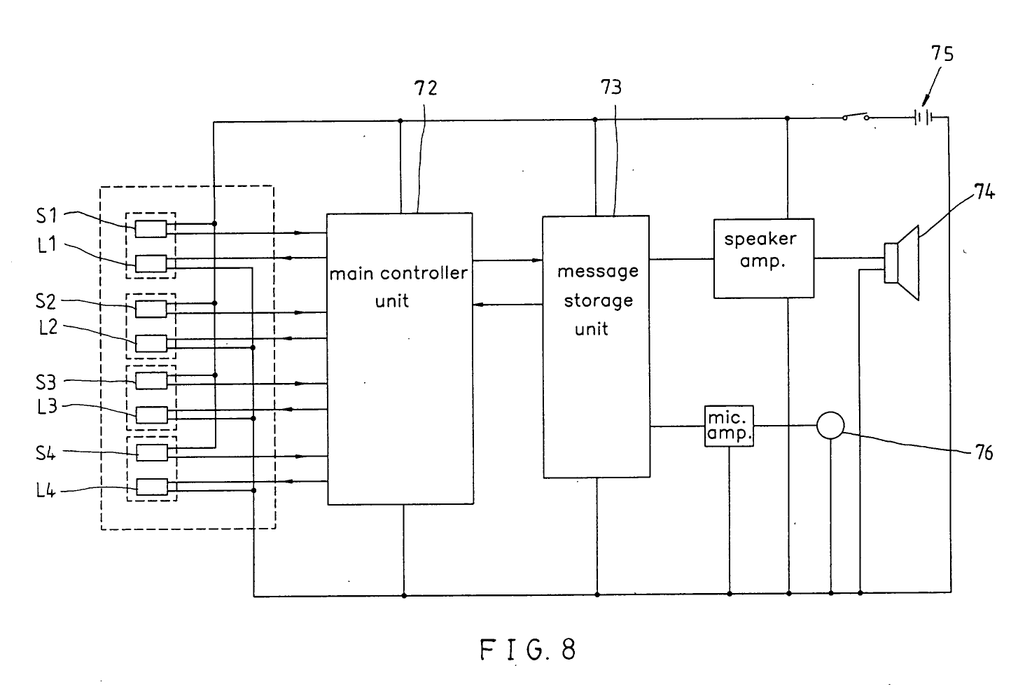

FIG. 7 and FIG. 8 show an audio generating assembly 2 of the second prefer embodiment of the present invention. Similar to the first prefer embodiment, the audio generating assembly 2 of the second embodiment comprises a case 71, a sensor array S1 to S4, a set of auxiliary lights L1 to L4, a main controller unit 72, a message storage unit 73, a speaker 74 and a power supply 75. Beside that, it further comprises an audio input assembly 76. The audio input assembly 76 is for user to input audio message and record the audio message in the message storage unit 73 according to an identify signal provided by the sensors S1 to S4. Thus, the audio generating assembly 2 of the second prefer embodiment has both functions of playing audio message and recording audio message. The message storage unit 73 of the second prefer embodiment is a recording-playback device, such as ISD4004, APR4800 or AMFRC0089 etc., which can read and write digital data therein. It further provides a record switch 763 at a panel 711 of the case 71 for turning on and turning off the recording function of the audio generating assembly 2 of the second prefer embodiment.

The audio input assembly 76 of the second embodiment has a socket 761 and a microphone 762 for putting into the socket 761. The socket 761 is disposed at one lateral side of the case 71 for the audio message received from the microphone 762 can record to the message storage unit 73.

In operating the recording function of the audio generating assembly 2 of the second prefer embodiment, when user turns a book to one page P and turns on the recording switch 763, the sensors S1 to S4 will identify a bar code BC on the page P and transmits an identify signal to the main controller unit 72. Then user can talk to the microphone 761 for the audio message can be stored in a predetermined address of the message storage unit 73 according to the identify signal. Next time, when reader turns the book to the page P, the sensors S1 to S4 will identify the bar code BC and playback the audio message that had been recorded before.

Hereunder are some default functions of the playing function and the recording function of the present invention:

1. When reader turns to a page and remain therein for a short period, such as 2 seconds, the playing function will be activated automatically.

2. The playing function will stop automatically when, 1. the audio message according to the page is playing out; 2. reader is turning to another page; 3. can not identify the bar code on the page.

3. After activating the playing function or the recording function, pressing the play switch or the record switch will stop the present function.

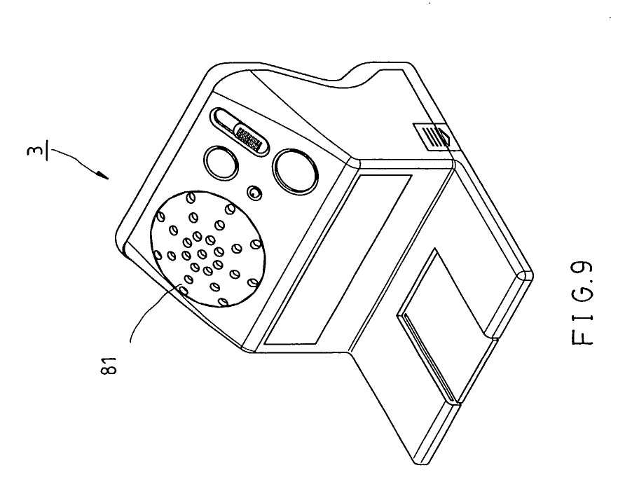

Please refer to FIG. 9, which shows an audio generating assembly 3 of the third prefer embodiment of the present invention. The third prefer embodiment is substantially as same as the second prefer embodiment, except that the third prefer embodiment provides with a speaker 81, which has both functions of broadcasting audio message and receiving audio message. That means when activating the playing function of the audio generating assembly 3 of the third prefer embodiment, the speaker 81 can broadcast audio message, but, when activating the recording function, the speaker will work like a microphone for user to input audio message.

What is claimed is:

1. An audio generating assembly for book and the like, comprising:
a case;
means for detachably fastening said case to a book and the like;
sensors provided at said case; said sensors being to receive optical signals reflected from a bar code on each page of the book and the like to provide an identify signal representing the page;
at least one auxiliary light provided at said case for illuminating the bar code on the page;
a message storage unit provided at said case; said message storage unit being to store audio message therein according to the identify signal;
a speaker provided at said case for broadcasting the audio message, and
a power supply being to provide a necessary electric power.

2. The audio generating assembly for book and the like as defined in claim 1, wherein further comprises a secure device being to attach to the book and the like, said case having an attaching segment thereon for engaging to said secure device to detachable fasten said case to the book and the like.

3. The audio generating assembly for book and the like as defined in claim 1, wherein said case has an attaching segment thereon; said attaching segment provided with repeat-adhesive tape thereon for detachable fastening said case to the book and the like.

4. The audio generating assembly for book and the like as defined in claim 1, wherein said case has a window thereon; said sensors and said auxiliary light being disposed in said case behind said window; a transparent piece disposed on said case in said window.

5. The audio generating assembly for book and the like as defined in claim 1, wherein further comprises a power switch for turning on and turning off said power supply and a play switch for turning on and turning off playing function.

6. The audio generating assembly for book and the like as defined in claim 1, wherein further comprises a main controller unit disposed at between said sensors, said auxiliary light and said message storage unit for exchanging signal and for controlling above elements to work.

7. The audio generating assembly for book and the like as defined in claim 6, wherein further comprises a circuit board disposed in said case for said sensors, said auxiliary light, said main controller unit and said message storage unit to be installed thereon.

8. The audio generating assembly for book and the like as defined in claim 1, wherein the bar code is printed on a tape attaching to the page of the book and the like.

9. An audio generating assembly for book and the like, comprising:
a case;
means for detachably fastening said case to a book and the like;
sensors provided at said case; said sensors being to receive optical signals reflected from a bar code on each page of the book and the like to provide an identify signal representing the page;
at least one auxiliary light provided at said case for illuminating the bar code on the page;
a message storage unit provided at said case; said message storage unit being to store audio message therein according to the identify signal;
means for receiving audio message, whereby recording the audio message to an specific address of said message storage unit according to the identify signal;
a speaker provided at said case for broadcasting the audio message, and
a power supply being to provide a necessary electric power.

10. The audio generating assembly for book and the like as defined in claim 9, wherein has a microphone and a socket disposed on said case for receiving said microphone therein.

11. The audio generating assembly for book and the like as defined in claim 9, wherein said speaker is to broadcast audio message in playing function and is to receive audio message in recording function.

12. The audio generating assembly for book and the like as defined in claim 9, wherein further comprises a power switch for turning on and turning off said power supply, a play switch for turning on and turning off playing function and a record switch for turning on and turning off playing function.
